(19) United States
(12) Patent Application Publication
(10) Pub. No.: US 2007/0065022 A1
(43) Pub. Date: Mar. 22, 2007

(54) Image signal processing apparatus and method

(75) Inventor: Keisuke Miyamoto, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC ELECTRONICS CORPORATION, Kawasaki (JP)

(21) Appl. No.: 11/511,354

(22) Filed: Aug. 29, 2006

(30) Foreign Application Priority Data
Sep. 22, 2005 (JP) 2005-274939

(51) Int. Cl. G06K 9/36

(52) U.S. Cl. 382/232

(57) ABSTRACT

To provide an image signal processing apparatus and method capable of reducing a memory capacity necessary for temporarily storing image data and suppressing an image processing delay. An image signal processing apparatus according to an embodiment of the invention includes: a filter that executes an image processing on captured image data from an image sensor on a line basis to generate YUV data, and outputs a synchronous signal each time the YUV data is generated up to a block; a buffer memory storing the YUV data in the order of generation; and a JPEG circuit that executes an image processing on the YUV data on a block basis in sync with the output synchronous signal to generate JPEG data.

### BACKGROUND OF THE INVENTION

1. Field of the Invention

The present invention relates to an image signal processing apparatus and method. In particular, the invention relates to an image signal processing apparatus and method for processing image signals from an image pick-up element.

2. Description of Related Art

Up to now, in the field of image pick-up apparatuses such as a digital camera, an apparatus that displays image signals (captured image data) obtained by an image sensor or other such image pick-up elements taking a subject image or records such signals on a recording medium such as a memory card has been widely used. In general, in the case of recording an image signal on a recording medium, the image signal is compressed to reduce a data amount so as to recode as many image signals as possible on one recording medium. For example, digital cameras compress the image signal based on the standard called JPEG (Joint Photographic Experts Group).

Japanese Unexamined Patent Application Publication No. 2000-23083 discloses such an image signal processing apparatus for compressing the image signal, for example. FIG. 7 is a block diagram showing the constitution of an image pick-up apparatus including an image signal processing apparatus similar to that of Japanese Unexamined Patent Application Publication No. 2000-23083.

As shown in FIG. 7, the conventional image pick-up apparatus includes an image sensor 710 that takes a subject image to generate a captured image data, and an image signal processing apparatus 700 that performs image processing such as compression on the captured image data. The conventional image signal processing apparatus 700 includes a CPU 701 that controls each unit, a filter 702 that generates YUV data using the captured image data, a JPEG circuit 703 that generates JPEG data using the YUV data, and a buffer memory 704 that temporarily stores the YUV data. These components are connected with a common bus 706.

The filter 702 receives the captured image data from the image sensor 710 on a line basis to process the received data on a line basis to generate YUV data. The JPEG circuit 703 processes data on the basis of block including 8 (lengthwise)×8 (widthwise) pixels, not on a line basis to produce JPEG data. Since a data unit of the filter 702 is different from the JPEG circuit 703, the filter 702 stores data corresponding to one frame in the buffer memory, after which the JPEG circuit 703 processes the data corresponding to one frame.

FIG. 8 shows a processing flow of the conventional image signal processing apparatus 700, that is, a flow from capture of image data to generation of JPEG data.

First, the CPU 701 sets the filter 702 (S801) and sets the JPEG circuit 703 (S802) to operate the filter 702 and the JPEG circuit 703. Next, the CPU 701 starts up the filter 702 (S803) and waits for the filter 702 to complete the processing (S804).

After the CPU 701 starts up the filter 702 in S803, the filter 702 processes data corresponding to one frame out of the captured image data input from the image sensor 710 (S805). At this time, the filter 702 converts the captured image data into RGB data on a line basis and then converts the RGB data into YUV data to store YUV data corresponding to one frame in the buffer memory 704.

Next, the filter 702 notifies the CPU 701 that the processing of the data corresponding to one frame is completed (S806). Next, the CPU 701 starts up the JPEG circuit 703 (S807) and waits for the JPEG circuit 703 to complete the processing (S808).

After the CPU 701 starts up the JPEG circuit 703 in S807, the JPEG circuit 703 compresses data corresponding to one frame out of the YUV data (S809). At this time, the JPEG circuit 703 retrieves the YUV data corresponding to one frame from the buffer memory 704 to compress the data for each block to generate JPEG data corresponding to one frame. Next, the JPEG circuit 703 notifies the CPU 701 that the processing of the data corresponding to one frame is completed (S810). In this way, a JPEG file of one frame is obtained.

Incidentally, as another conventional image signal processing apparatus, ones disclosed in Japanese Unexamined Patent Application Publication Nos. 2001-285776 and 2005-182384 are known. The apparatus of Japanese Unexamined Patent Application Publication No. 2001-285776 stops the data input when data is written to a buffer memory up to a predetermined size. The apparatus of Japanese Unexamined Patent Application Publication No. 2005-182384 executes processing in a predetermined data unit such that a memory controller of a buffer memory monitors write addresses. The apparatuses of Japanese Unexamined Patent Application Publication Nos. 2001-285776 and 2005-182384 need to give a special function to an image sensor control circuit or a memory controller other than the image processing circuit, resulting in a complicated circuit. Further, if a data unit is different, other circuits than the image processing circuit should be corrected. Thus, these apparatuses are not adaptable to a wide variety of applications.

As mentioned above, in the conventional image signal processing apparatus, a data unit is different between the filter that executes processing on a line basis and the JPEG circuit that executes processing on a block basis. Thus, after the filter stores image data corresponding to one frame in the buffer memory, the JPEG circuit starts compressing the data. Hence, the conventional image signal processing apparatus has problems that it is necessary to provide a buffer memory having a capacity enough to store image data corresponding to at least one frame, and an image processing involves a delay of one frame or more.

In recent years, as the number of pixels in the image sensor increases, a data amount of image signal corresponding to one frame increases. Thus, problems about an increase in memory capacity for data corresponding to one frame and about a processing delay become more serious. For example, in the case of processing image data of 2000×1600 pixels corresponding to one frame, the buffer memory needs to have a memory capacity corresponding to 1600 lines. As a result, a period necessary for storing data corresponding to 1600 lines becomes a processing delay. The increase in memory capacity becomes a big problem in the field of digital camera that is now processing toward size and cost reduction. A delay in image processing causes a problem because a high processing speed is required of the digital camera for continuous shooting.

### SUMMARY OF THE INVENTION

An image signal processing apparatus according to an aspect of the invention includes: a first image processor that executes an image processing on image data in a first data unit to generate first image data, and outputs a synchronous signal each time the first image data is generated up to a second data unit; and a second image processor unit that executes an image processing on the first image data in the second data unit in sync with the output synchronous signal to generate second image data.

According to the image signal processing apparatus, the first and second image processors execute processing in accordance with the data unit of the second image processor, whereby even if the data unit in the first image processor differs from that of the second image processor, it is unnecessary to store image data corresponding to one frame in the image data storage. Accordingly, a memory capacity of the image data storage can be saved and an image processing delay can be suppressed.

An image signal processing method according to another aspect of the invention includes: executing an image processing on image data in a first data unit to generate first image data, and outputting a synchronous signal each time the first image data is generated up to a second data unit; and executing an image processing on the first image data in the second data unit in sync with the output synchronous signal to generate second image data.

According to the image signal processing method, the first and second image processors execute processing in accordance with the data unit of the second image processor, whereby even if the data unit in the first image processor differs from that of the second image processor, it is unnecessary to store image data corresponding to one frame. Accordingly, a memory capacity necessary for storing image data can be reduced and an image processing delay can be suppressed.

According to the present invention, it is possible to provide an image signal processing apparatus and method capable of reducing a memory capacity necessary for temporarily storing image data and suppressing an image processing delay.

### BRIEF DESCRIPTION OF THE DRAWINGS

The above and other objects, advantages and features of the present invention will be more apparent from the following description taken in conjunction with the accompanying drawings, in which:

FIG. 1 is a block diagram of an image pick-up apparatus according to an embodiment of the present invention;

FIGS. 2A to 2C show data used in an image signal processing apparatus according to the embodiment of the present invention;

FIG. 3 is a block diagram of a buffer memory according to the embodiment of the present invention;

FIG. 4 is a block diagram of the image signal processing apparatus according to the embodiment of the present invention;

FIG. 5 is a sequence diagram of an operation of the image signal processing apparatus according to the embodiment of the present invention;

FIGS. 6A to 6G are timing charts of an operation of the image signal processing apparatus according to the embodiment of the present invention;

FIG. 7 is a block diagram of a conventional image pick-up apparatus; and

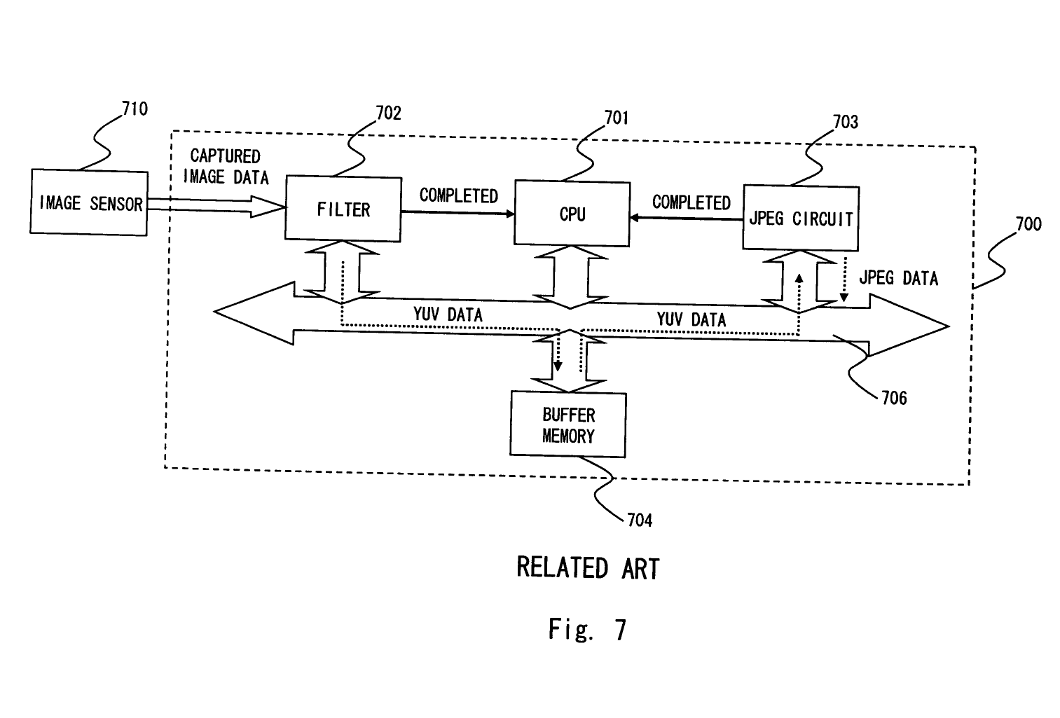

FIG. 8 is a sequence diagram of an operation of the conventional image signal processing apparatus.

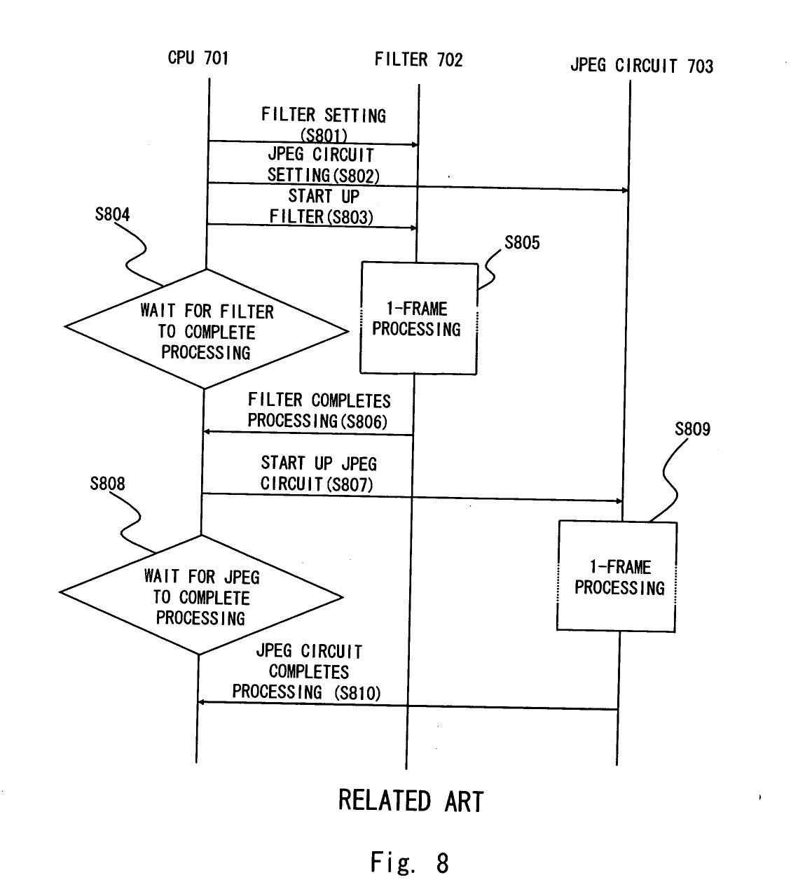

### DESCRIPTION OF THE PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposed.

### First Embodiment

To begin with, an image signal processing apparatus according to a first embodiment of the present invention is described. An image signal processing apparatus of this embodiment has a feature that, when a filter for processing an image on a line basis and a JPEG circuit for processing an image on a block basis process image data through a buffer memory, the data is processed while keeping synchronization therebetween on a block basis.

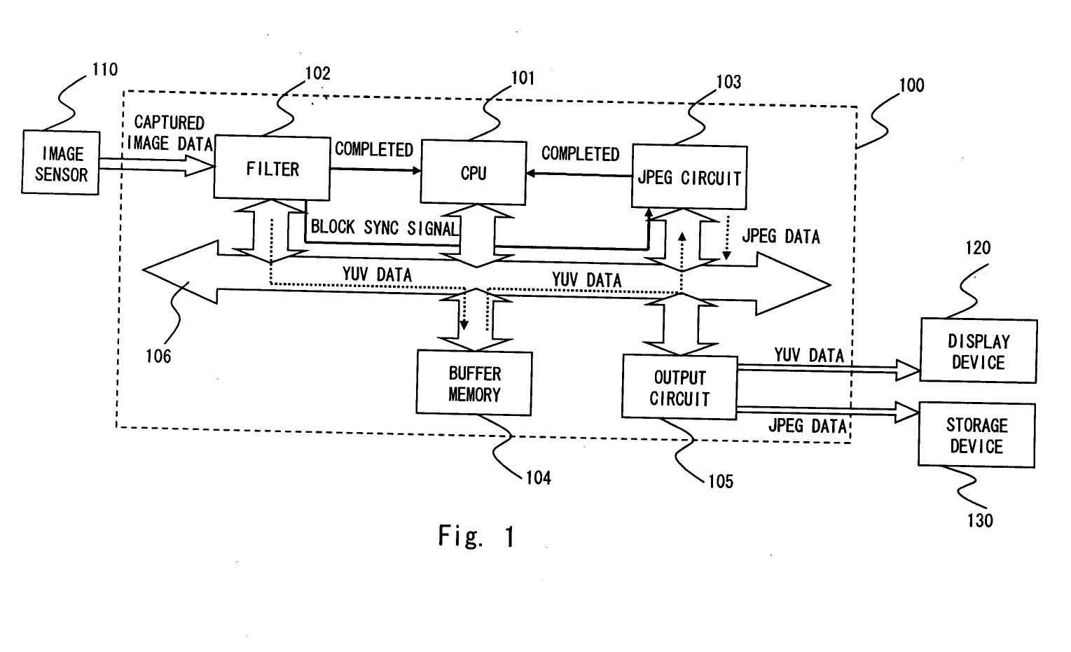

Referring to FIG. 1, the configuration of an image pick-up apparatus of this embodiment is described. As shown in FIG. 1, the image pick-up apparatus includes an image sensor 110, an image signal processing apparatus 100, a display device 120, and a storage device 130.

The image sensor (image pick-up element) 110 is a semiconductor element that takes a subject image. The image sensor 110 photoelectrically converts light reflected by a subject to generate captured image data. In practice, although a signal output from the image sensor 110 is an analog signal in some cases, the signal is converted into digital captured image data by an A/D converter (not shown). The image sensor 110 is, for example, a CCD (Charge Coupled Device) or CMOS (Complementary Metal Oxide Semiconductor).

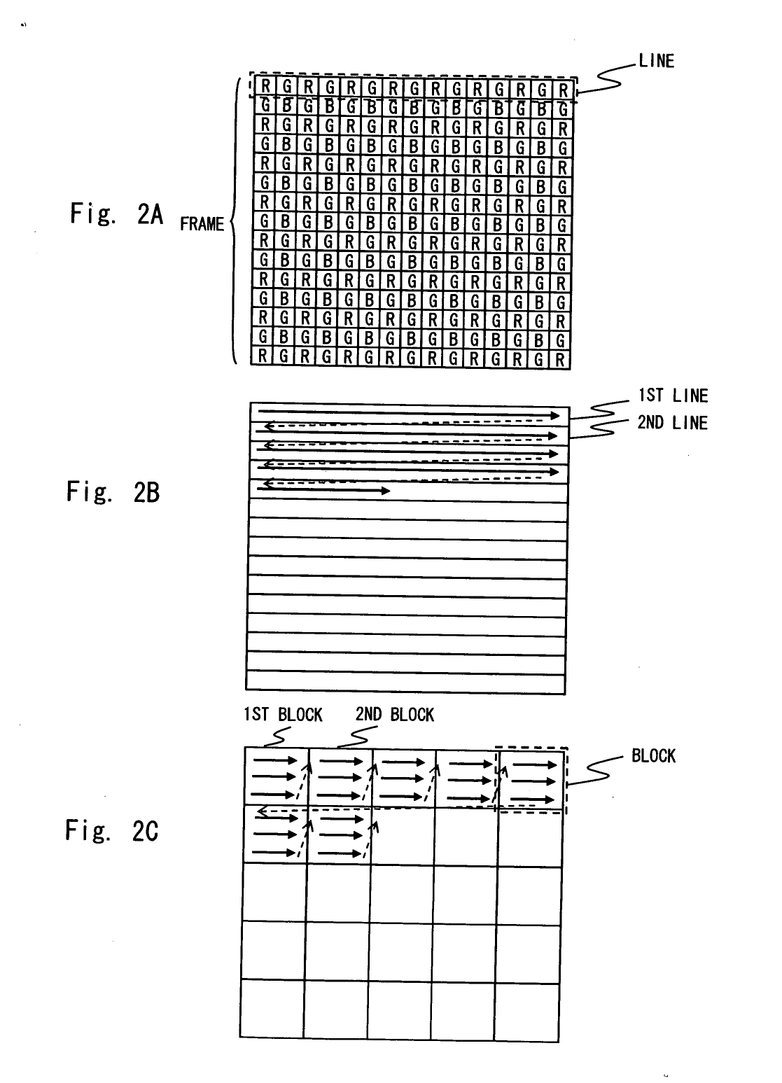

The image sensor 110 generates captured image data of Bayer array as shown in FIG. 2A. Then, the captured image data is output to the image signal processing apparatus 100 on a line basis. In the illustrated example, on a first line, a data array of “R (red) G (green)” repeatedly appears, and on a second line, a data array “G (green) B (blue)” repeatedly appears.

The display device 120 is an LCD (Liquid Crystal Display) or the like, which displays YUV data subjected to image processing with the image signal processing apparatus 100, on a screen as an image. The storage device 130 is a memory card or the like, which stores JPEG data subjected to image processing with the image signal processing apparatus 100.

The image signal processing apparatus 100 executes image processing such as conversion/compression on the captured image data from the image sensor 110. For example, the image signal processing apparatus 100 converts the captured image data into YUV data to output the converted data or compresses the captured image data into JPEG data to output the compressed data. The image signal processing apparatus 100 is composed of a one-chip semiconductor device. In particular, in this embodiment, as described below, a memory capacity of a buffer memory 104 can be reduced, so it is easy to implement the device on a single chip.

As shown in FIG. 1, the image signal processing apparatus 100 includes a CPU 101, a filter 102, a JPEG circuit 103, the buffer memory 104, and an output circuit 105, which are connected to a common bus 106.

The CPU 101 controls an operation of each unit of the image signal processing apparatus 100. For example, functions of the units are performed by the CPU 101 executing a processing based on control programs stored in, for example, the buffer memory 104 or other such memories, in cooperation with a hardware component. The CPU 101 starts up the filter 102 or the JPEG circuit 103 via the bus 106 or receives a notification that the filter 102 or the JPEG circuit 103 completes the processing based on interrupt or the like.

The filter 102 executes image processing on the captured image data from the image sensor 110 to generate YUV data to store the generated YUV data into the buffer memory 104 through the bus 106. The filter 102 performs image processing on a line basis as shown in FIG. 2B. That is, the filter 102 processes data in the first line through, and then processes data in the next, second line through. Such operation is repeated up to the end of one frame. Receiving the captured image data from the image sensor 110, the filter 102 converts the received data into YUV data in the order which the data was received on a line basis to store the generated YUV data into the buffer memory 104 on a line basis. Further, each time an amount of YUV data generated with the filter 102 reaches a data unit of the JPEG circuit 103, that is, a block, the filter 102 sends a block synchronous signal to the JPEG circuit 103. That is, the filter 102 is a first image processor that performs image processing (conversion to YUV data) on the captured image data in a first data unit (on a line basis) to generate first image data (YUV data), and also sends a synchronous signal each time an amount of generated first image data reaches a second data unit (on a block basis).

The JPEG circuit 103 retrieves the YUV data from the buffer memory 104 through the bus 106 to compress the obtained YUV data in accordance with the JPEG standard to generate JPEG data. Further, the JPEG circuit 103 stores the generated JPEG data in the buffer memory 104 through the bus 106, or outputs the data from the output circuit 105. The JPEG circuit 103 processes an image on a block basis as shown in FIG. 2C. In other words, the JPEG circuit 103 processes data in the first block through, and then processes data in the next, second block through. Such operation is repeated to the end of one frame. Here, one block corresponds to MCU (Minimum Coded Unit) of the JPEG standard. One block is smaller than one frame, and includes plural lines. More specifically, one block includes N (row)×M (column) pixels (where N and M are positive integer), for example, 8×8 pixels. Receiving the block synchronous signal from the filter 102, the JPEG circuit 103 retrieves the YUV data on a block basis to generate JPEG data on a block basis in the order which the block was received. That is, the JPEG circuit 103 is a second image processor that performs image processing (generation of JPEG data) on the stored first image data (YUV data) in a second data unit (on a block basis) in sync with the block synchronous signal to thereby generate second image data (JPEG data).

In order to process the data in sync with the block synchronous signal, it is preferred that a processing speed of the JPEG circuit 103 be higher than that of the filter 102. For example, a period necessary for the filter 102 to process data of 8 lines is shorter than a period necessary for the JPEG circuit 103 to process data of 8 lines including plural blocks. In other words, the filter 102 is different from the JPEG circuit 103 in terms of a processing speed as well as a data unit. If the processing speed of the JPEG circuit 103 is lower than the filter 102, it is necessary to prevent unprocessed data in the buffer memory 104 from being rewritten.

The buffer memory 104 is an image data storage that temporarily stores the YUV data (first image data) generated with the filter 102. For example, the buffer memory 104 includes a memory for storing data, and a memory controller for controlling an operation of writing/reading data to/from the memory. The memory is an SDRAM (Synchronous DRAM), an SRAM (Static Random Access Memory), or the like.

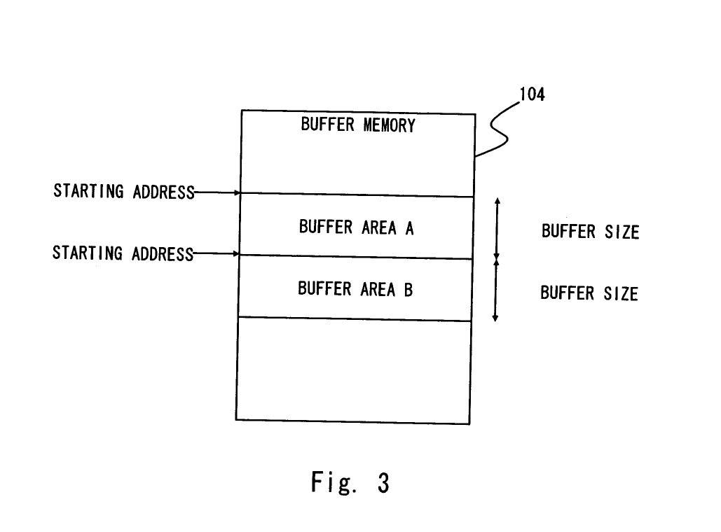

A memory map of the buffer memory 104 is set as shown in FIG. 3. The buffer memory 104 includes two buffer areas (storage areas) A and B for storing the YUV data. A buffer size of the buffer areas A and B is determined depending on a block size that is a data unit of the JPEG circuit 103, namely, a size of data obtained within a period from the input of a block synchronous signal to the next block synchronous signal output from the filter 102. For example, the buffer areas A and B have a size enough to store YUV data of 8 lines. That is, the total capacity of the buffer areas A and B is enough to store YUV data of 16 lines.

The filter 102 stores the YUV data alternately in the buffer area A and the buffer area B. That is, the filter 102 repeatedly writes data in the buffer areas in the order of A→B→A. Then, the JPEG circuit 103 retrieves the YUV data from the buffer area A or B that has already stored the data. That is, the JPEG circuit 103 accesses the buffer areas in the order of A→B→A with a delay of 8 lines relative to the filter 102. Hence, the JPEG circuit 103 completes processing of all YUV data in the buffer area A while the filter 102 transfers data to the buffer area B, so by the time the filter 102 starts transferring data to the buffer area A after the completion of the transfer of the data to the buffer area B, the data in the buffer area A has been all processed and thus can be overwritten with other data. Since the filter 102 outputs a block synchronous signal upon the completion of the transfer to the buffer area B, the JPEG circuit 103 decides that the YUV data in the buffer area B is ready to process, and processes the data in the buffer area B.

In FIG. 1, the output circuit 105 sends the YUV data or JPEG data generated with the image signal processing apparatus 100 to the display device 120 or the storage device 130. For example, if the image pick-up apparatus is a digital camera, the YUV data or JPEG data is output from the output circuit 105 by a user pressing a shutter button. Before the user presses the shutter button, the YUV data generated with the filter 102 is output from the output circuit 105 to the display device 120 and displayed on a monitor screen. After the user presses the shutter button, a control signal is input to the CPU 101. Then, in response to an instruction from the CPU 101, the YUV data generated with the filter 102 is stored in the buffer memory 104, and the JPEG circuit 103 generates JPEG data. Then, the JPEG data is stored in the buffer memory 104. The output circuit 105 obtains and outputs the generated JPEG data to the storage device 130, and a JPEG file is stored in a memory card or the like.

The bus 106 is an AHB bus, a PCI (Peripheral Components Interconnect) bus, or the like, and is a multibus-master synchronous bus. The bus 106 is a general-purpose bus that can burst-transfer a large amount of data at high speed. Because of the general-purpose bus, the buffer memory 104 or the like may be a general-purpose memory, making it possible to save a cost.

Although not shown, the bus 106 is provided with a bus arbiter (bus arbitrating unit). The bus arbiter controls accesses of a bus master to the bus. The CPU 101, the filter 102, the JPEG circuit 103, and the output circuit 105 access the bus 106, as the bus master. Each bus master sends a request to access the bus to the bus arbiter. The bus arbiter controls accesses to the bus, and then gives the bus master a permission to access the bus. In this way, the bus master can access the bus. When any bus master sends an access request, if the requested bus is accessed by another bus master, the access to the bus is permitted after the access of the other bus master is completed.

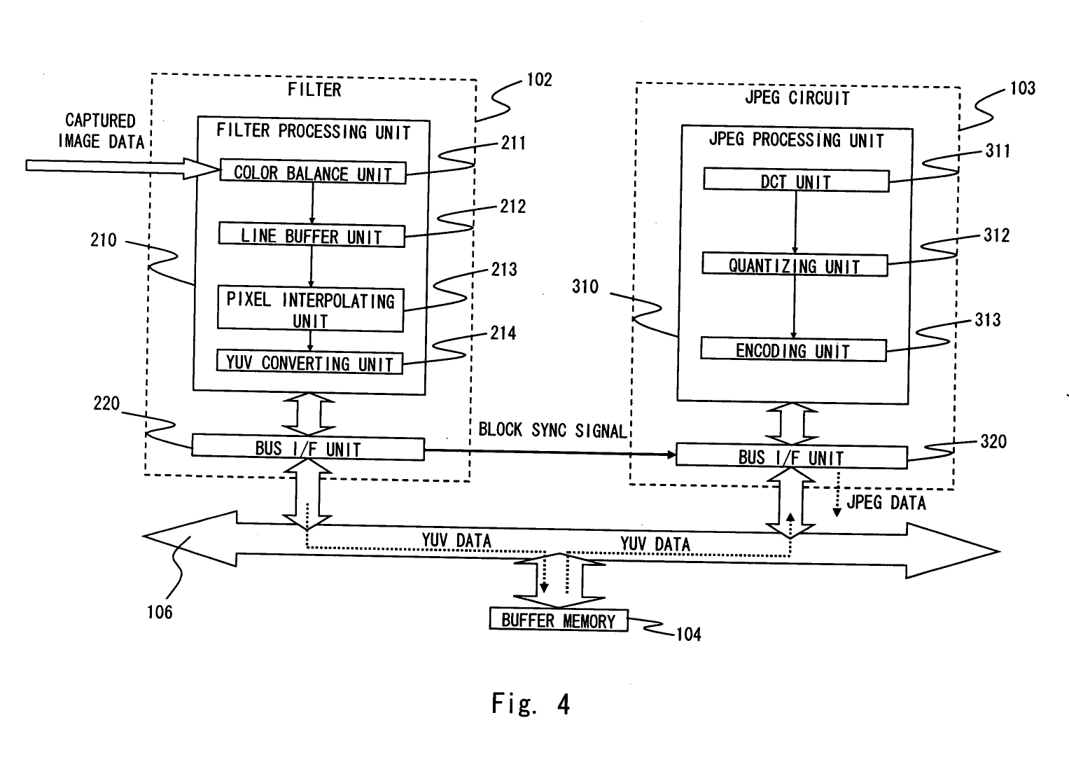

Referring next to FIG. 4, the configuration of the image signal processing apparatus of this embodiment is described. In FIG. 4, the CPU 101 and the output circuit 105 are not shown, and the configuration of the filter 102 and the JPEG circuit 103 is described.

The filter 102 includes a filter processing unit 210 and a bus IF (interface) unit 220. The bus IF unit 220 sends a request to access a bus/receives a permission to access a bus to/from the bus arbiter, and controls data input/output through the bus 106. The bus IF unit 220 sends the YUV data generated with the filter processing unit 210 on a line basis to the buffer memory 104 through the bus 106, and directly outputs a block synchronous signal to the JPEG circuit 103. The bus IF unit 220 transfers the YUV data on a line basis, and counts the number of times the data is transferred. Then, after the YUV data corresponding to 8 lines are transferred, the bus IF unit 220 outputs a block synchronous signal. Since the block synchronous signal is output to the JPEG circuit 103 not through the bus 106 or CPU 101, a procedure for transferring the signal is unnecessary, and there is no transfer waiting time. A timing delay is small.

The filter processing unit 210 converts the captured image data to generate YUV data. The filter processing unit 210 includes a color balance unit 211, a line buffer unit 212, a pixel interpolating unit 213, and a YUV converting unit 214.

The color balance unit 211 receives the captured image data from the image sensor 110 on a line basis to adjust a white balance of the captured image data. The color balance unit 211 adjusts the RGB signal level of the captured image data to output the adjusted captured image data on a line basis.

The line buffer unit 212 collectively outputs the captured image data corresponding to 3 lines, which are processed by the color balance unit 211. The line buffer unit 212 stores the captured image data until the color balance unit 211 outputs data corresponding to 3 lines, and outputs the stored captured image data at a time so that the data corresponding to 3 lines is processed by the subsequent pixel interpolating unit 213.

The pixel interpolating unit 213 processes the captured image data of 3 lines output from the line buffer unit 212 by use of a 3×3 pixel filter to output RGB data. The pixel interpolating unit 213 generates data of a required color based on data on an adjacent pixel. For example, regarding a pixel of B at the center of 3×3 pixels, R or G data is generated based on data on a pixel of R or G around the pixel of B. The pixel interpolating unit 213 interpolates between pixel data to produce RGB data, and the RGB data is output on a line basis.

The YUV converting unit 214 converts the RGB data output from the pixel interpolating unit 213 on a line basis, into the YUV data. The YUV converting unit 214 converts the RGB data into YUV data including a Y signal (luminance signal), a U signal (difference between the luminance signal and a blue component), and a V signal (difference between the luminance signal and a red component). A data amount ratio among the Y signal, the U signal, and the V signal varies depending on the format of YUV data. For example, in the YUV 444 format, one Y signal corresponds to one U signal and one V signal. In the YUV 422 format, two Y signals correspond to one U signal and one V signal. In the YUV 420 format, four Y signals correspond to one U signal and one V signal. If a buffer size of the buffer memory 104 is the YUV data of 8 lines, an actual buffer size corresponds to 8 lines including the Y signal, the U signal, and the V signal based on the YUV format.

The JPEG circuit 103 includes a JPEG processing unit 310, and a bus IF unit 320. The bus IF unit 320 controls data input/output through the bus 106 through the bus 106 similar to the bus IF unit 220. When receiving the block synchronous signal from the filter 102, the bus IF unit 320 retrieves the YUV data from the buffer memory 104 on a block basis through the bus 106 to output the retrieved data to the JPEG processing unit 310. For example, the bus IF unit 320 retrieves the YUV data of 8 lines stored in the buffer memory on a block basis with the YUV data being divided into blocks each including 8×8 pixels.

The JPEG processing unit 310 compresses the YUV data to generate JPEG data. The JPEG processing unit 310 includes a DCT (Discrete Cosine Transform) unit 311, a quantizing unit 312, and an encoding unit 313.

The DCT unit 311 executes DCT conversion on the YUV data input from the bus IF unit 320 on a block basis. The DCT unit 311 executes DCT-conversion on YUV data of 8×8 pixels to generate and output 64 (=8×8) DCT coefficients.

The quantizing unit 312 quantizes the DCT coefficients generated by the DCT unit 311 on a block basis. The quantizing unit 312 quantizes and outputs the 64 DCT coefficients by use of a quantization table or the like.

The encoding unit 313 encodes the DCT coefficients quantized by the quantizing unit 312 on a block basis. The encoding unit 313 encodes the 64 quantized DCT coefficients with the Huffman code to output the JPEG data of one block.

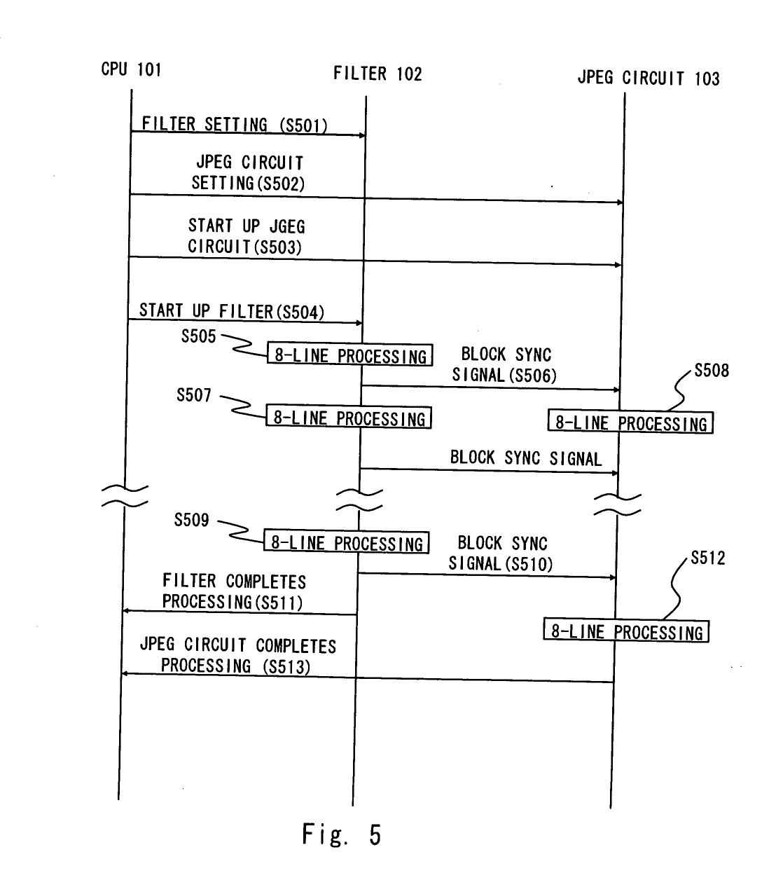

Referring next to FIG. 5, an operation of the image signal processing apparatus of this embodiment is described. FIG. 5 shows a processing flow of how the image signal processing apparatus 100 generates the JPEG data using the captured image data from the image sensor 110.

First, the CPU 101 sets the filter 102 (S501) and sets the JPEG circuit 103 (S502) to operate the filter 102 and the JPEG circuit 103. For example, the CPU 101 sets a starting address and a buffer size of the buffer areas A and B of the buffer memory 104 for the filter 102 and the JPEG circuit 103. The buffer areas A and B can be shared by setting the same starting address and buffer size for the filter 102 and the JPEG circuit 103.

Next, the CPU 101 starts up the JPEG circuit 103 (S503). In this embodiment, the JPEG circuit 103 starts processing in step with the block synchronous signal from the filter 102. For that reason, the JPEG circuit 103 is activated before the filter 102 so that the JPEG circuit 103 waits for the block synchronous signal to input.

Next, the CPU 101 starts up the filter 102 (S504). The filter 102 processes the captured image data of 8 lines input from the image sensor 110 (S505). At this time, the filter 102 generates RGB data using the captured image data on a line basis and then converts the RGB data into YUV data to store the YUV data of up to 8 lines in the buffer area A of the buffer memory 704 on a line basis.

Next, the filter 102 outputs a block synchronous signal to the JPEG circuit 103 at the completion of processing data of 8 lines. At this time, the filter 102 generates YUV data of 8 lines. After the completion of storing the data in the buffer memory 104, the filter outputs a block synchronous signal (S506). Next, the filter 102 processes subsequent 8 lines of the captured image data (S507). The filter 102 processes the subsequent 8 lines of the captured image data to produce YUV data and write the YUV data of up to 8 lines onto the buffer area B of the buffer memory 704 on a line basis.

Receiving the block synchronous signal from the filter 102 in S506, the JPEG circuit 103 retrieves YUV data from the buffer memory 104 and processes the data of 8 lines (S507). At this time, the JPEG circuit 103 retrieves the YUV data from the buffer area A of the buffer memory 104 on the basis of 8×8 blocks to generate JPEG data. This processing is repeated throughout 8 lines.

Next, the filter 102 repeats generating YUV data of 8 lines and outputting a block synchronous signal, and the JPEG circuit 103 repeats generating JPEG data of 8 lines in accordance with the block synchronous signal.

Next, the filter 102 outputs a block synchronous signal to the JPEG circuit 103 (S510) upon the completion of processing the last 8 lines of a frame (S509), and notifies the CPU 101 that the processing of the filter is completed (S511). For example, the notification that the filter 102 completes the processing is issued by the filter 102 interrupting the CPU 101 not through the bus 106.

Receiving the block synchronous signal regarding the last processing of the frame, from the filter 102 in S510, the JPEG circuit 103 retrieves YUV data from the buffer memory 104 and processes the data of 8 lines (S512), and notifies the CPU 101 that the JPEG circuit completes the processing (S513). For example, the notification that the JPEG circuit 103 completes the processing is sent by the JPEG circuit 103 interrupting the CPU 101 as in the filter 102. In this way, a JPEG file of one frame is obtained and output from the output circuit 105.

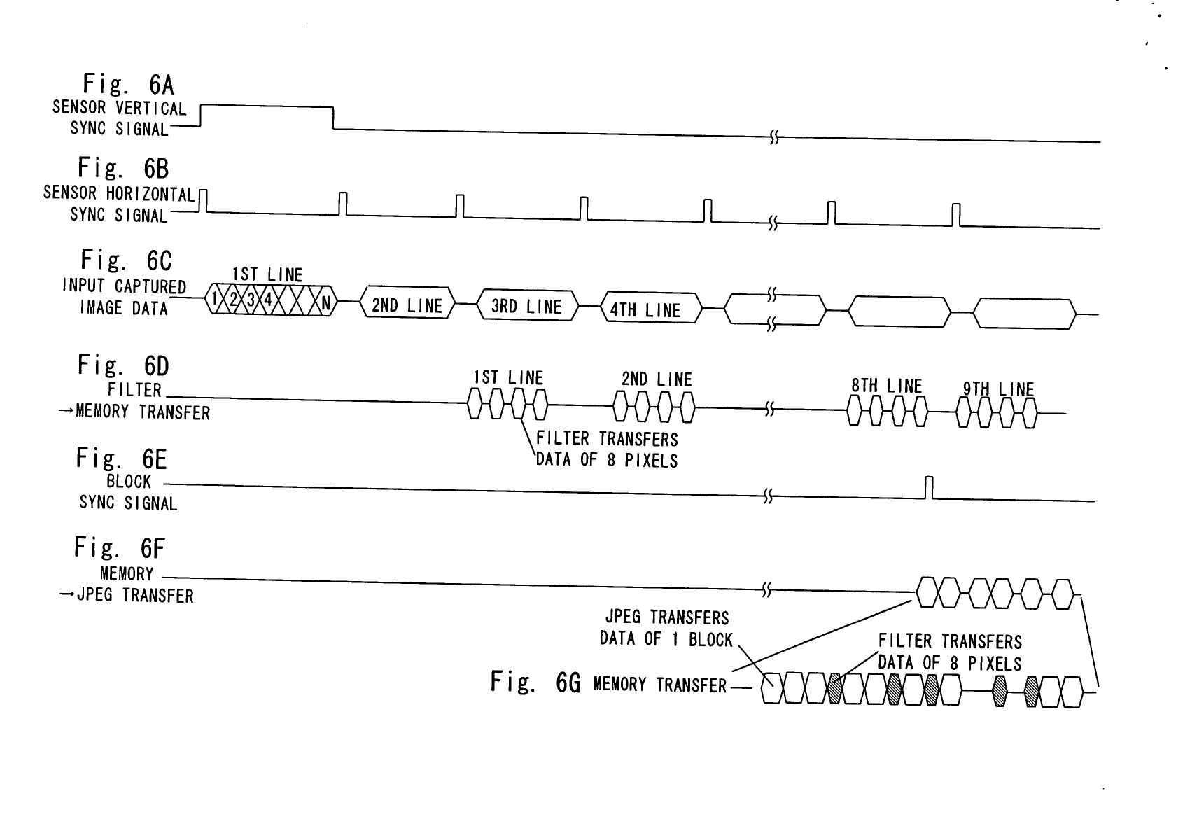

Timing charts of FIGS. 6A to 6G show an operation of the image signal processing apparatus of this embodiment similar to FIG. 5.

The image sensor 110 sends to the image signal processing apparatus 100 a sensor vertical synchronous signal of FIG. 6A, a sensor horizontal synchronous signal of FIG. 6B, and captured image data of FIG. 6C. The sensor vertical synchronous signal represents synchronization of captured image data in one frame, and captured image data obtained within a period from the input of a vertical synchronous signal to the next vertical synchronous signal corresponds to data of one frame. The sensor horizontal synchronous signal represents synchronization of captured image data in one line, and captured image data obtained within a period from the input of a horizontal synchronous signal to the next horizontal synchronous signal corresponds to data of one line. The captured image data are input on a line basis at regular intervals in sync with the horizontal synchronous signal. In the captured image data in each line, signals each representing R, G, or B are continuously arranged in the order from the first pixel of the line.

As shown in FIG. 6D, the filter 102 transfers YUV data to the buffer memory 104 with a delay of 2 lines from the input of the captured image data. As described above, the filter 102 processes the captured image data by 3 lines while interpolating between pixels on the basis of 3×3 pixels. Hence, the YUV data is output with a delay of 2 lines. Further, in FIG. 6D, the data is transferred in several batches (8 pixels), not continuously throughout one line. The transfer in several batches reduces a period during which the bus is occupied. Thus, the JPEG circuit 103 or the like can access the bus while the filter 102 transfers the data of one line.

As shown in FIG. 6E, after the completion of the transfer of YUV data of 8 lines, the filter 102 outputs a block synchronous signal. Then, as shown in FIGS. 6F and 6G, after the transmission of the block synchronous signal, the YUV data is transferred from the buffer memory 104 to the JPEG circuit 103. The YUV data is transferred from the buffer memory 104 to the JPEG circuit 103 in several batches on a block basis. At this time, the transfer of YUV data of 9^{th} and subsequent lines with the filter 102 competes with the transfer of YUV data of 1^{st} and subsequent lines with the JPEG circuit 103, so the bus arbiter controls the accesses to the bus, and the data are transferred.

As discussed above, in this embodiment, the filter and JPEG circuit that execute processing through the buffer memory process data in sync with each other in accordance with a data unit of the JPEG circuit at the subsequent stage. Thus, a buffer memory corresponding to one frame becomes unnecessary unlike the conventional apparatus. For example, for processing image data including 2000×1600 pixels/frame, the conventional apparatus requires a memory capacity corresponding to 1600 lines. In this embodiment, however, a buffer memory capacity corresponding to 16 lines suffices therefore. Even if the number of lines in one frame increases, it is unnecessary to enlarge a buffer memory. Accordingly, the buffer size can be effectively reduced.

Further, since the conventional apparatus stores data of one frame in a buffer memory, image processing involves a delay of one frame. However, in this embodiment, a size of data stored in the buffer memory is 8 lines, only a delay of 8 lines is involved, so a delay in image processing can be reduced.

Furthermore, the memory may be a small-capacity buffer memory, so a small-capacity memory such as an SRAM can be used instead of a large-capacity memory such as an SDRAM. The large-capacity memory is bottle necked on performance because of its long access latency. On this other hand, the SRAM can be incorporated into an LSI and an access latency is short, so a high-speed processing can be executed.

### Other Embodiments

Incidentally, although the above embodiment describes the case where the filter and the JPEG circuit process an image through the buffer memory, the present invention is not limited thereto, and the filter may process an image through the buffer memory in cooperation with other circuits that differ from the filter in a data unit, for example, a circuit compressing an image based on a format other than the JPEG format, a circuit decompressing a compressed image, or a circuit rotating/resizing an image.

Further, the above embodiment describes image processing executed by use of the two image processors and the buffer memory. However, the present invention is not limited thereto, and three or more image processors may be provided. In this case as well, the image processors are synchronized in accordance with a data unit of the second image processor, whereby the buffer memory can be downsized.

It is apparent that the present invention is not limited to the above embodiment that may be modified and changed without departing from the scope and spirit of the invention.

What is claimed is:

1. An image signal processing apparatus, comprising:
a first image processor that executes an image processing on image data in a first data unit to generate first image data, and outputs a synchronous signal each time the first image data is generated up to a second data unit; and
a second image processor unit that executes an image processing on the first image data in the second data unit in sync with the output synchronous signal to generate second image data.

2. The image signal processing apparatus according to claim 1, wherein the second data unit is smaller than one frame.

3. The image signal processing apparatus according to claim 1, wherein the first data unit is data of one line including a plurality of pixels, and the second data unit is data of a plurality of lines.

4. The image signal processing apparatus according to claim 1, wherein the second data unit is data of one block including N-row×M-column pixels (where N and M are positive integer).

5. The image signal processing apparatus according to claim 1, further comprising an image data storage storing the generated first image data in the order of generation; wherein the first image processor outputs the synchronous signal after storing the first image data in the second data unit into the image data storage.

6. The image signal processing apparatus according to claim 1, wherein an image processing speed of the second image processor is higher than an image processing speed of the first image processor.

7. The image signal processing apparatus according to claim 5, wherein the first and second image processors and the image data storage are connected to a common bus,
the first image processor stores the first image data in the image data storage through the bus,
the second image processor retrieves the first image data from the image data storage through the bus.

8. The image signal processing apparatus according to claim 7, wherein the synchronous signal is directly output from the first image processor to the second image processor not through the bus.

9. The image signal processing apparatus according to claim 5, wherein the first image processor stores the first image data in the image data storage in the first data unit,
the second image processor retrieves the first image data from the image data storage in the second data unit.

10. The image signal processing apparatus according to claim 9, wherein the first image processor stores the first image data in the first data unit into the image data storage in plural batches.

11. The image signal processing apparatus according to claim 5, wherein the image data storage has first and second storage areas,
the first image processor alternately stores the first image data in the first and second storage areas, and
the second image processor retrieves the first image data from the first or second storage area in which the first image processor completes storing the data.

12. The image signal processing apparatus according to claim 1, wherein the image processing of the first image processor is conversion of a color form of the image data, and
the image processing of the second image processor is compression of the first image data.

13. An image signal processing method, comprising:
executing an image processing on image data in a first data unit to generate first image data, and outputting a synchronous signal each time the first image data is generated up to a second data unit; and
executing an image processing on the first image data in the second data unit in sync with the output synchronous signal to generate second image data.

14. The image signal processing method according to claim 13, wherein the second data unit is smaller than one frame.

15. The image signal processing method according to claim 13, wherein the first data unit is data of one line including a plurality of pixels, and the second data unit is data of a plurality of lines.

16. The image signal processing method according to claim 13, wherein the second data unit is data of one block including N-row×M-column pixels (where N and M are positive integer)

17. The image signal processing method according to claim 13, further comprising storing the generated first image data in the order of generation; wherein the synchronous signal is output after storing the first image data in the second data unit.
